(19) United States
(12) Patent Application Publication
(10) Pub. No.: US 2007/0127668 A1
(43) Pub. Date: Jun. 7, 2007

(54) Method and system for performing a conference call

(76) Inventors: Deepak P. Ahya, Plantation, FL (US); Adeel Mukhtar, Coral Springs, FL (US); Satyanarayana T., Bangalore (IN)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/292,878

(22) Filed: Dec. 2, 2005

(51) Int. Cl. H04M 3/42

(52) U.S. Cl. 379/202.01

(57) ABSTRACT

A method and a system for performing a conference call in a network (102) are disclosed. The network (102) includes a plurality of electronic devices (104, 106, 108 110, 112, and 114) that interact with each other. The method includes receiving (302) audio streams from the plurality of electronic devices, and compiling (304) them so that the audio streams received are separate relative to each other. The method also includes transmitting (306) the audio streams to the plurality of electronic devices, and processing (308) the audio streams in at least one electronic device. The audio streams are also positioned in a virtual conference room (512), associated with at least one electronic device.

### FIELD OF THE INVENTION

The present invention relates generally to conference calls in a network. More specifically, it relates to a method and system for performing an enhanced conference call in the network.

### BACKGROUND OF THE INVENTION

Conference calls are becoming an increasingly popular technique of communication for corporate organizations as well as individuals. In a conference call, multiple participants communicate with each other over a wired or wireless network at a given time. These participants may be present in the same place or in different locations. This makes interaction possible between the participants, irrespective of their respective geographic locations.

There is plenty of evidence that individuals still prefer face-to-face conversations instead of conference calls. In face-to-face conversations, participants are able to perceive (or map) the voices of each of the participants distinctly. While in a conference call, participants are unable to perceive clearly which voice belongs to which participant. The voices of the participants are difficult to differentiate since they appear to be coming from a single source.

A face-to-face conversation therefore gives a real-time communication experience, unlike in a conference call. Further, with the number of participants increasing in a conference call, the distinction between voices becomes difficult.

### BRIEF DESCRIPTION OF THE DRAWINGS

The present invention is illustrated by way of an example, and not limitation, in the accompanying figures, in which like references indicate similar elements, and in which:

FIG. 1 shows a block diagram illustrating an environment for a conference call between a plurality of electronic devices in a network, in accordance with an embodiment of the invention.

FIG. 2 shows a block diagram illustrating an environment for the conference call between the plurality of electronic devices, in accordance with another embodiment of the invention.

FIG. 3 shows a flowchart illustrating a method for performing a conference call in a network, in accordance with an embodiment of the invention.

FIG. 4 shows a flowchart illustrating a method for processing audio streams, in accordance with an embodiment of the invention.

FIG. 5 shows a system diagram illustrating the communication between a server and an electronic device, in accordance with an embodiment of the invention.

FIG. 6 shows a block diagram illustrating various elements of an aggregating unit, in accordance with an embodiment of the invention.

FIG. 7 shows a block diagram illustrating an exemplary Real-time Transport Protocol (RTP) payload structure, in accordance with an embodiment of the invention.

FIG. 8 shows a block diagram of a processing unit, in accordance with an embodiment of the invention.

FIG. 9 shows a block diagram of a virtual conference room, in accordance with an embodiment of the invention.

FIG. 10 shows a flow diagram illustrating messaging between an electronic device and a server, in accordance with an embodiment of the invention.

FIG. 11 shows a conference call server, in accordance with an embodiment of the invention.

FIG. 12 shows a communication device, in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE VARIOUS EMBODIMENTS

Various embodiments of the present invention provide a method and system for performing a conference call in a network. The network includes a plurality of electronic devices. The method includes receiving the audio streams from the plurality of electronic devices. The received audio streams are compiled so that the audio streams are kept separate relative to each other. Further, the audio streams are transmitted to the plurality of electronic devices. The audio streams are processed in at least one of the plurality of electronic devices, so that the audio streams are audibly positioned in a virtual conference room associated with at least one electronic device.

Before describing in detail the method and system for performing the conference call in the network, it should be observed that the present invention resides primarily in the method steps and system components, which are employed to perform the conference call between the plurality of electronic devices.

Accordingly, the method steps and apparatus components have been represented where appropriate by conventional symbols in the drawings, showing only those specific details that are pertinent to understanding the present invention, so as not to obscure the disclosure with details that will be readily apparent to those of ordinary skill in the art having the benefit of the description herein.

In this document, relational terms such as first and second, and so forth may be used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

The term “another,” as used herein, is defined as at least a second or more. The terms “including” and/or “having,” as used herein, are defined as comprising.

A “set” as used in this document, means a non-empty set (i.e., comprising at least one member). The term “another,” as used herein, is defined as at least a second or more. The terms “including” and/or “having,” as used herein, are defined as comprising. The term “coupled,” as used herein with reference to electro-optical technology, is defined as connected, although not necessarily directly, and not necessarily mechanically. The term “program,” as used herein, is defined as a sequence of instructions designed for execution on a computer system. A “program,” or “computer program,” may include a subroutine, a function, a procedure, an object method, an object implementation, an executable application, an applet, a servlet, a source code, an object code, a shared library/dynamic load library and/or other sequence of instructions designed for execution on a computer system.

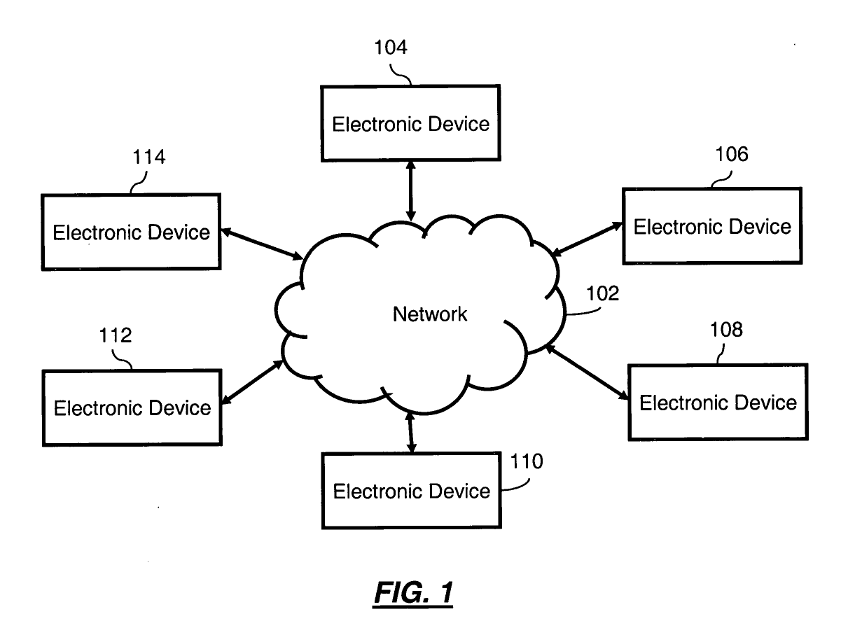

FIG. 1 shows a block diagram illustrating an environment for a conference call between a plurality of electronic devices in a network 102, in accordance with an embodiment of the invention. The environment includes a plurality of electronic devices 104, 106, 108, 110, 112, and 114. The plurality of electronic devices are connected to each other through the network 102. The electronic devices can be either wireless devices or wired devices. In an embodiment, the electronic devices are Internet Protocol (IP)-enabled devices. The network 102 can be a combination of two or more different types of networks, for example, a combination of a cellular phone network and the Internet.

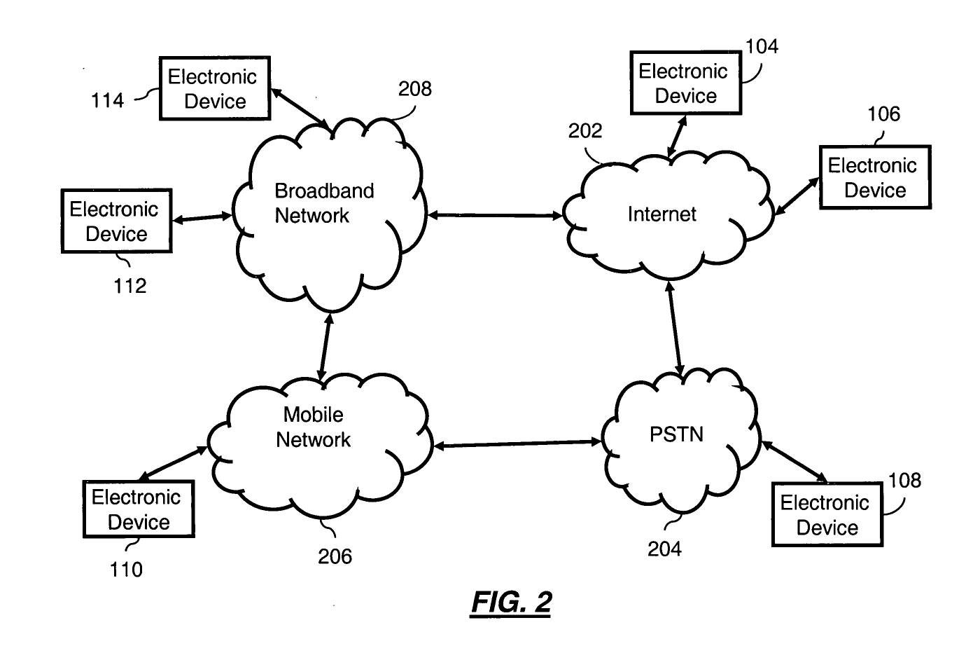

FIG. 2 shows a block diagram illustrating an environment for the conference call between the plurality of electronic devices, in accordance with another embodiment of the invention. Each of the plurality of electronic devices is connected to each another through different types of networks in the network 102. Examples of the different types of networks include the Internet 202, a Public Switched Telephone Network (PSTN) 204, a mobile network 206, and a broadband network 208. For example, the electronic device 104, which is connected to the Internet 202, interacts with the electronic device 110, which is connected to the mobile network 206. Similarly, the electronic device 104 and the electronic device 110 can communicate with each other through the broadband network 208 or the PSTN network 204. In this way, any electronic device can communicate with another electronic device through any combination of the different types of networks.

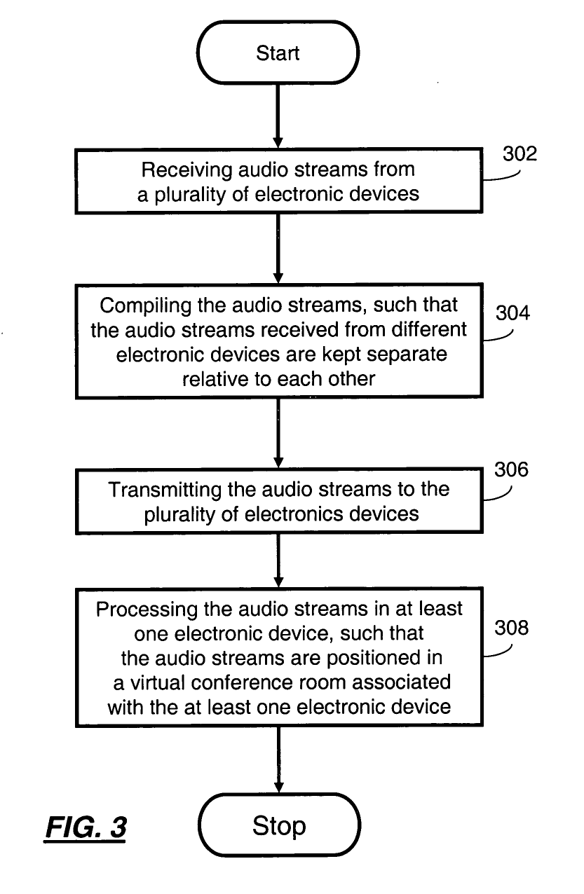

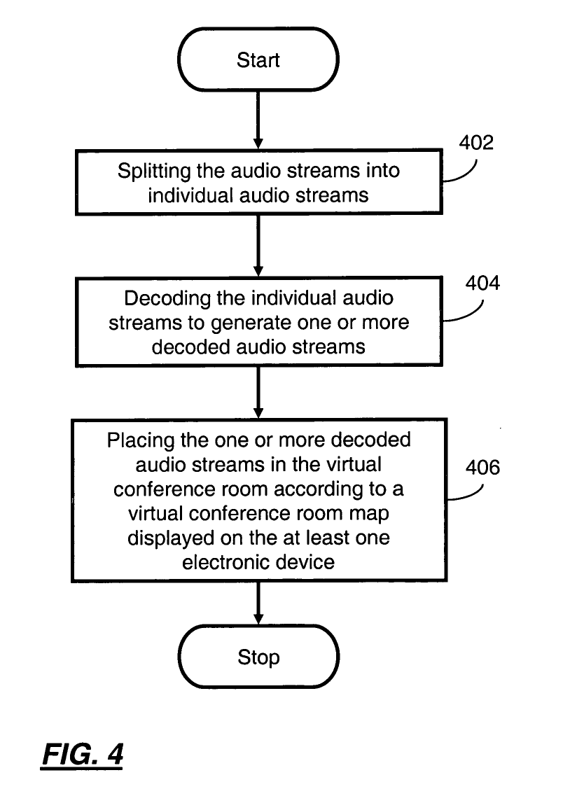

FIG. 3 shows a flowchart illustrating a method for performing a conference call in the network 102, in accordance with an embodiment of the invention. At step 302, audio streams are received from the plurality of electronic devices 104, 106, 108, 110, 112, and 114. In an embodiment, the audio streams are received at a server. The received audio streams can be in a compressed form. At step 304, the audio streams are compiled so that they are kept separate relative to each other. In an embodiment, a server performs the step 304. The audio streams are kept separate relative to each other by tagging each of the audio streams with respective tags. These tags identify the audio streams. Each tag contains information about the corresponding electronic device with which the audio stream is associated. At step 306, the tagged audio streams are transmitted back to the plurality of electronic devices. In another embodiment, a server transmits the tagged audio streams. The plurality of electronic devices, which receive the tagged audio streams, are associated with a virtual conference room. The virtual conference room is a part of at least one electronic device from the electronic devices 104, 106, 108, 110, 112, and 114. At step 308, the audio streams are processed so that they are audibly positioned in the virtual conference room associated with at least one electronic device among the plurality of electronic devices. By audibly positioned it is meant that the user hears the particular audio stream as if the audio source were physically present at the position around the listener from where it appears to be coming, as perceived by the user. In an embodiment, the audio streams are positioned in the virtual conference room so that a 3 Dimensional (3D) audio output is generated. The processing of the audio streams is described in conjunction with FIG. 4.

In an embodiment, at step 304, the audio streams received at the server can be treated in two different ways. In one embodiment, the received audio streams at the server are decoded and re-encoded by using a specific speech coding algorithm. The use of the specific speech coding algorithm simplifies software architecture present in the electronic devices receiving the audio streams, as it requires the same decoding algorithm to decode all received audio streams. In another embodiment, the audio streams may not be decoded and re-encoded at the server. Hence, all possible decoding algorithms need to be supported at the receiving electronic devices, one for each type of audio streams. Some examples of algorithms used for speech coding include, but are not limited to, Adaptive Multi Rate (AMR), Vector-Sum Excited Linear Prediction (VSELP), Advanced Multi-Band Excitation (AMBE) and so forth.

FIG. 4 shows a flowchart illustrating a method for processing the audio streams, in accordance with an embodiment of the invention. The processing of the audio streams is performed in at least one of the electronic devices. At step 402, the audio streams are split into individual audio streams, which correspond to the respective electronic devices with which they are associated. At step 404, the individual audio streams are decoded to generate one or more decoded audio streams. An instance of an algorithm is used to decode an individual audio stream. In other words, a copy of the algorithm is used to decode an individual audio stream. At step 406, each of the decoded audio streams is placed in the virtual conference room according to a virtual conference room map displayed on display units of at least one the electronic devices. A user is able to change the arrangement of the decoded audio streams in the virtual conference room map.

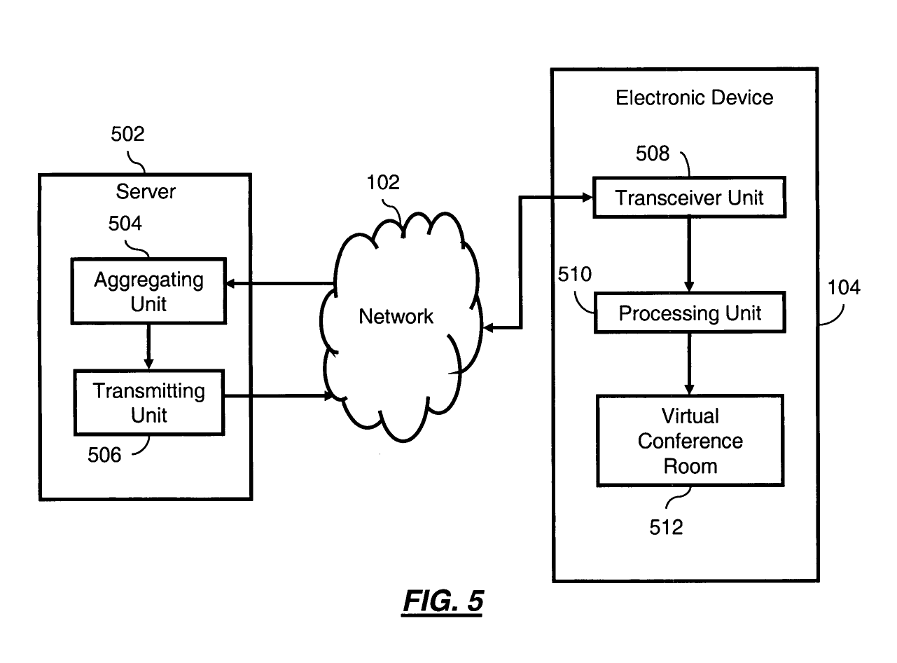

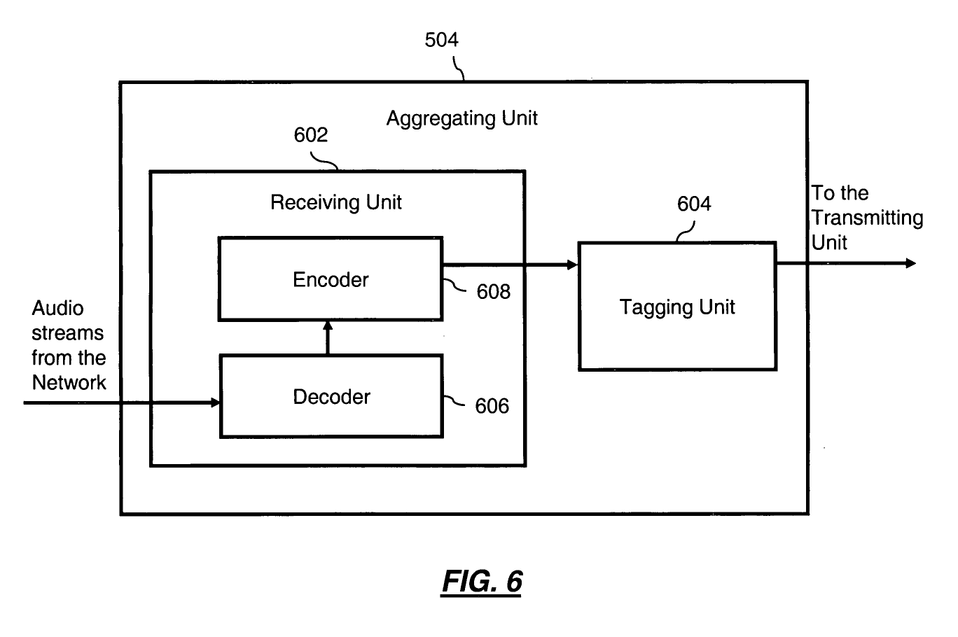

FIG. 5 shows a system diagram illustrating the communication between a server 502 and the electronic device 104, in accordance with an embodiment of the invention. The communication between the server 502 and the electronic device 104 is carried out through the exchange of audio streams. In one embodiment, the server 502 acts as a soft switch, wherein a plurality of audio streams received from the plurality of electronic devices are kept separate relative to each other by the soft switch. The server 502 includes an aggregating unit 504 and a transmitting unit 506. The electronic device 104 includes a transceiver unit 508, a processing unit 510, and a virtual conference room 512. The aggregating unit 504 compiles the audio streams received from the plurality of electronic devices. The audio streams are compiled so that they are kept separate relative to each other by tagging each of the audio streams with their respective tags. Various components of the aggregating unit 504 are described in conjunction with FIG. 6. The tagged audio streams are sent to the transmitting unit 506, which transmits the tagged audio streams to the plurality of electronic devices through the network 102. For example, the audio streams are received in the transceiver unit 508 of the electronic device 104. The transceiver unit 508 passes the audio streams to the processing unit 510, which further processes and positions them in the virtual conference room 512.

FIG. 6 shows a block diagram illustrating various elements of the aggregating unit 504, in accordance with an embodiment of the invention. The aggregating unit 504 includes a receiving unit 602 and a tagging unit 604. In one embodiment, the audio streams received from the network 102 are passed through a decoder 606 and an encoder 608 present in the receiving unit 602. The audio streams are decoded by the decoder 606 by using the corresponding decoding algorithms. The audio streams are further re-encoded by the encoder 608 by using a particular speech coding algorithm. Encoding all the audio streams by using the same speech coding algorithm at the server 502 ensures a simplified software architecture at receiving electronic devices, which can use a single decoding algorithm to decode the audio streams. In another embodiment, the decoding and encoding of the audio streams is not performed at the server 502. Hence, the receiving electronic devices have to support different speech coding algorithms for decoding the audio streams, one for each type of audio streams.

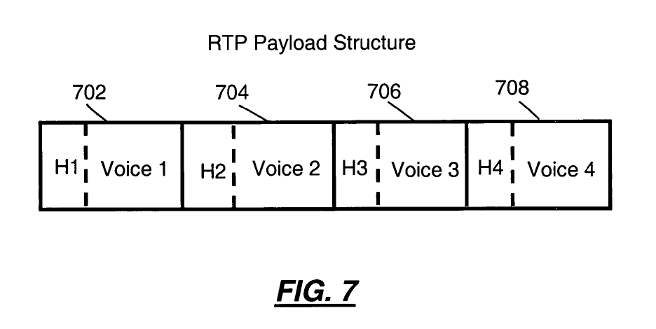

The receiving unit 602 passes the audio streams to the tagging unit 604, where the tagging unit 604 tags each of the audio streams with the respective tags. The tags may contain identification information about the plurality of participants in the conference call. Some examples of identification information include name of the participant, telephone number, IP address, location and so forth. In one embodiment, the tagging unit 604 tags at least one of the audio streams with at least one tag. The aggregating unit 504 passes the tagged audio streams to the transmitting unit 506. Tagging the audio streams keeps them separate relative to each other. The tagged audio streams are assembled in a definite structure, which is explained in conjunction with FIG. 7.

FIG. 7 shows a block diagram illustrating an exemplary Real-time Transport Protocol (RTP) payload structure, in accordance with an embodiment of the invention. The tagged audio streams can be assembled by using an RTP, so that each of the audio streams is associated with its respective tags. In one embodiment, Voice-over-Internet-Protocol (VoIP) includes the packet structure of the RTP payload. The tagged audio streams are arranged in the RTP payload structure present in the RTP layer. In one embodiment, the RTP payload includes four audio streams: voice stream 1 702, voice stream 2 704, voice stream 3 706, and voice stream 4 708, associated with tags H1, H2, H3, and H4, respectively. The tags contain information pertaining to the respective participants, from which the audio streams are generated. The RTP is further described in the Request for Comments (RFC) document no.1889, entitled ‘RTP: A Transport Protocol for Real-time Applications’.

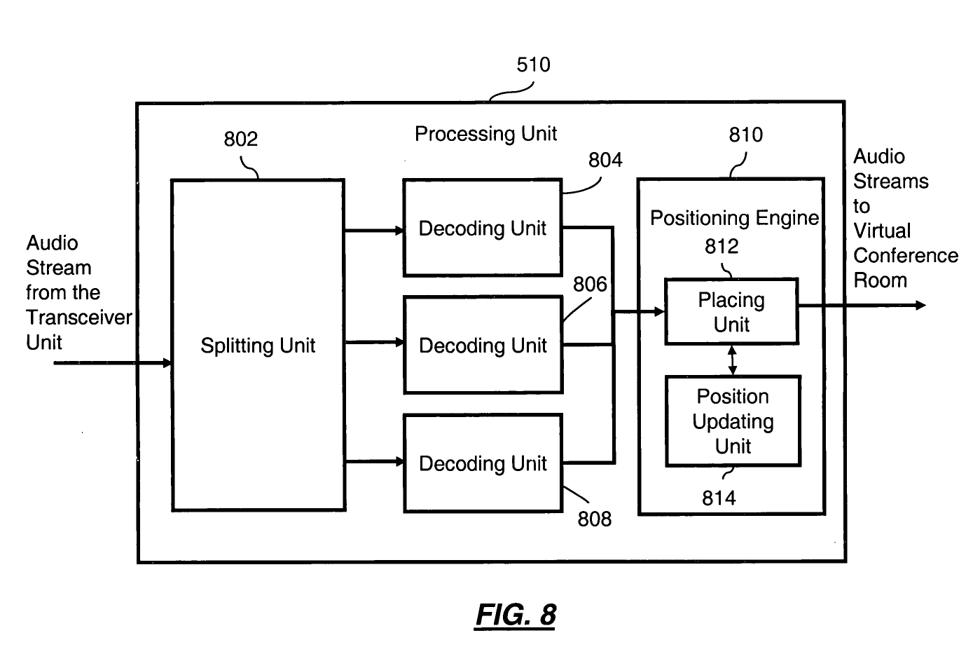

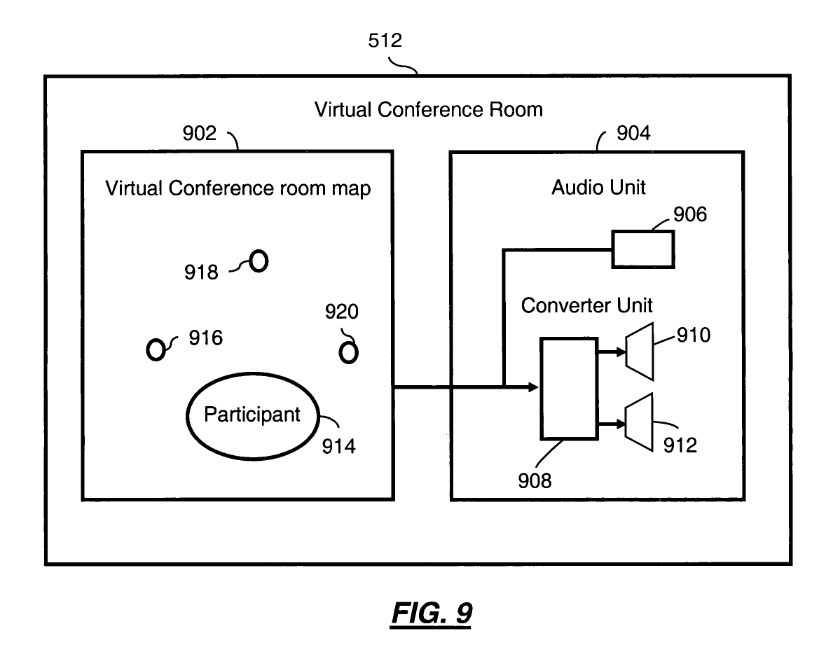

FIG. 8 shows a block diagram illustrating various elements of the processing unit 510, in accordance with an embodiment of the invention. The tagged audio streams are split by a splitting unit 802 into individual audio streams, which correspond to the electronic devices that have sent the audio streams. The individual audio streams are decoded by using instances of a decoding unit. The number of decoding units used is same as the number of individual audio streams. For example, three instances of the decoding unit, i.e., decoding units 804, 806, and 808, are used for decoding the individual audio streams. The decoded audio streams are passed to a positioning engine 810, to place them in a virtual conference room 512 (shown in FIGS. 5 and 9), according to a virtual conference room map displayed on at least one of the plurality of electronic devices.

The positioning engine 810 includes a placing unit 812 that is operatively coupled to a position-updating unit 814. The position- updating unit 814 passes the co-ordinates of one or more decoded audio streams to the positioning engine 810. The co-ordinates of the one or more decoded audio streams represent their position in a virtual conference room map present in the electronic device 104. The placing unit 812 is capable of altering the arrangement of the one or more decoded audio streams on the virtual conference room map, based on their co-ordinates.

FIG. 9 shows a system diagram illustrating various element of the virtual conference room 512, in accordance with an embodiment of the invention. The virtual conference room 512 includes a virtual conference room map 902 and an audio unit 904. The audio unit 904 includes a headset 906, a converter unit 908, and a plurality of speakers. The audio unit 904 provides a 3 Dimensional (3D) audio output to the user of the electronic device 104. The converter unit 908 includes a digital-to-analog card to convert a digital audio stream to an analog audio stream, and an amplifier to amplify the analog audio stream. In one exemplary embodiment, the plurality of speakers include a left speaker 910 and a right speaker 912 providing 3D audio output. In another embodiment, the audio streams are provided to the headset 906. The headset 906 is a 3D audio output headset. The audio unit 904 can utilize any existing 3D audio positioning technology to produce 3D audio. An example of 3D audio positioning technology is Sonaptic 3D Audio Engine by Sonaptic Limited.

The virtual conference room map 902 displays a representation of the plurality of participants. For example, a participant 914 represents a user of the electronic device 104. Similarly, participants 916, 918 and 920 are representations of the users of electronic devices 108, 110 and 112, respectively. In an embodiment, the virtual conference room map 902 can be displayed on a liquid crystal display (LCD) display of the electronic device. Some examples of the representations on the virtual conference room map 902 include a photograph, a graphical representation of a user, a phone book representation of the user, and so forth. For a change in the position of participants 916, 910 and 912, the position updating unit 814 passes the co-ordinates of the participants 916, 910, and 912 on the virtual conference room map 902 to the placing unit 812. The placing unit 812 is capable of altering the arrangement of the one or more decoded audio streams on the virtual conference room map 902. The combination of the representation of the audio streams in the virtual conference room map 902 and the audio output provides a 3D effect in an enhanced conference call. For the user, the audio output seems to come from different directions. Hence, the user is able to perceive the voices of the different users.

In an embodiment, a participant can upload a seating position of a plurality of participants in the conference call to a server. The information of the seating position can then be distributed by a conference call server to the plurality of participants. The seating position of each participant can be indicated by using circular coordinates (angle in degrees and the distance from the center in centimeters). For example, if participant A is seated at an angle of 22° 10′ and at a distance of 2.34 m, it can be indicated as “22.10 d 234 cm”. This information can be used by positioning engines present in the electronic devices to place the participants in the virtual conference rooms according to the coordinates sent by the server.

It should be noted that in various embodiments of the present invention, the virtual conference room map may not be present in the electronic device. In such cases, the audio unit alone is utilized to provide 3D audio experience corresponding to the different audio streams received by the electronic device. Hence, a user is able to differentiate different participants in the conference call, since the audio of different participants appear to be coming from different directions.

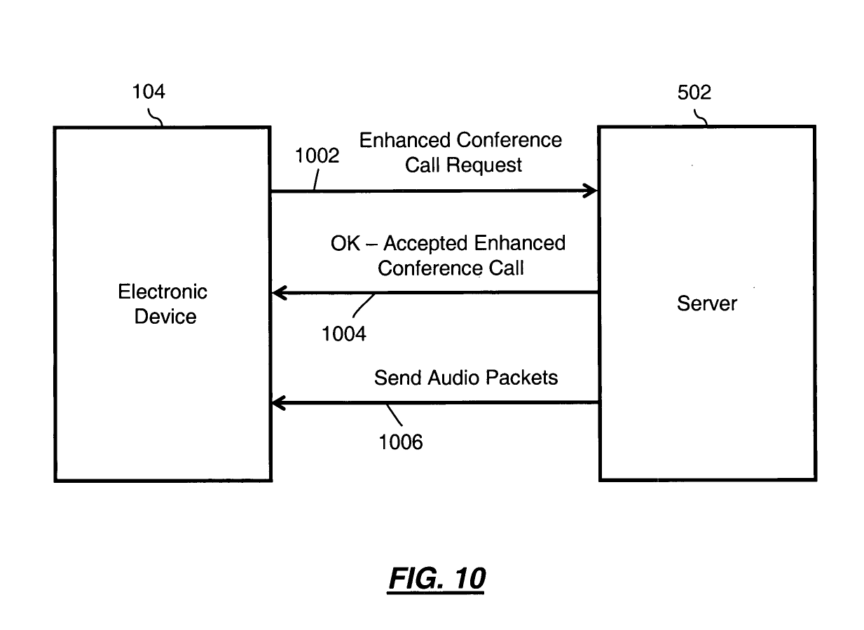

FIG. 10 shows a flow diagram illustrating messaging between the electronic device 104 and the server 502, in accordance with an embodiment of the invention. The electronic device 104 and the server 502 communicate with each other, to initiate the enhanced conference call. An enhanced conference call request message 1002 is sent to the server 502 from the electronic device 104. The enhanced conference call request message 1002 instructs the server 502 not to mix the audio streams from the plurality of electronic devices, but to keep them separate relative to each other. The server 502 then sends an OK-accepted enhanced conference call message 1004 to the electronic device 104, and assembles the audio streams from the plurality of electronic devices in IP packets. Thereafter, audio packets 1006, containing separate audio streams, are sent by the server 502 to the electronic device 104. In another embodiment, when a new participant joins the enhanced conference call, all the participants in the call are informed that the new participant has joined them. Hence, the entry and exit of the new participant in the enhanced conference call is seamless. The participant 914 allows the new participant to join the conference call anywhere on the virtual conference room map 902. If the position of the new participant in the enhanced conference call is not specified, the participant is automatically mapped to an available space on the virtual conference room map 902.

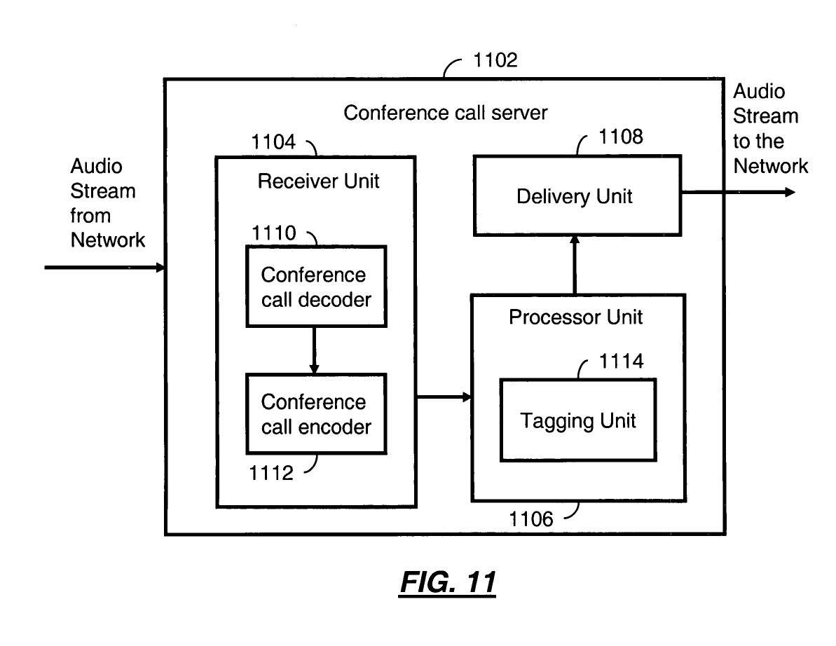

FIG. 11 shows a conference call server 1102 that is capable of performing an enhanced conference call, in accordance with an embodiment of the invention. The conference call server 1102 includes a receiver unit 1104, a processor unit 1106, and a delivery unit 1108. The receiver unit 1104 receives the audio stream from the network 102, and has a conference call decoder 1110 and a conference call encoder 1112. The conference call decoder 1110 decodes the audio streams and passes them to the conference call encoder 1112. The encoded audio streams are passed to a processor unit 1106, which includes a tagging unit 1114. The tagging unit 1114 tags at least one of the audio streams with at least one tag. The tag comprises information about the electronic device from which the audio streams are generated. The delivery unit 1108 is operatively coupled to the processor unit 1106. The tagged audio streams are passed from the processing unit 1106 to the delivery unit 1108, which delivers them to at least one of the plurality of electronic devices that are capable of conducting the enhanced conference call.

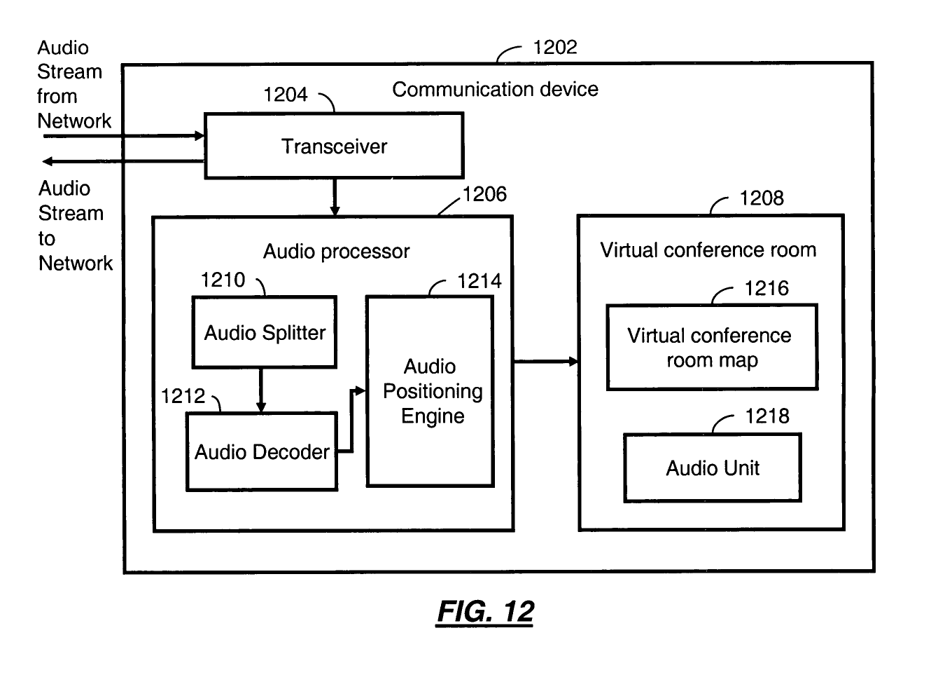

FIG. 12 shows a communication device 1202 that is capable of performing an enhanced conference call, in accordance with an embodiment of the invention. The communication device 1202 receives the audio streams from the plurality of electronic devices and includes a transceiver 1204, an audio processor 1206, and a virtual conference room 1208. The transceiver 1204 exchanges the audio streams with a plurality of communication devices in the network 102, and transmits and receives the audio streams from the plurality of communication devices. The received audio streams are passed to the audio processor 1206 by the transceiver 1204. The audio processor 1206 includes an audio splitter 1210, an audio decoder 1212, and an audio positioning engine 1214. The audio splitter 1210 splits the audio streams into individual audio streams. These audio streams are passed to the audio decoder 1212, which decodes them and passes the decoded audio streams to the audio positioning engine 1214. The audio positioning engine 1214 positions the decoded audio streams in the virtual conference room 1208. Moreover, the audio positioning engine 1214 is capable of altering the arrangement of the decoded audio streams in the virtual conference room 1208, which includes a virtual conference room map 1216 and an audio unit 1218. The arrangement of the audio stream is displayed on the virtual conference room map 1216, which may be displayed on a display unit in the electronic device 104. For example, the display unit can be a liquid crystal display (LCD) present in communication device 1202. A change in the arrangement of the audio streams on the virtual conference room map 1216 is based on the co-ordinates of the displayed audio streams in the virtual conference room map 1216. The audio streams appear to be emerging from different directions to a user using the communication device 1202. The audio unit 1218 is operatively coupled with the virtual conference room map 1216. The audio unit 1218 provides a 3D audio to a user using the communication device 1202, based on the co-ordinates of the displayed audio streams in the virtual conference room map 1216. The display of the audio streams on the virtual conference room map 1216 can be modified by the user by changing their position on the display. The displayed audio streams in the virtual conference room map and the audio, together, enable the user to distinctly perceive the audio from the different electronic devices.

Various embodiments of the present invention, as described above, provide a method and system for performing a conference call in a network giving a user a perception that an audio is coming from a given direction. Further, there is a seamless entry and seamless exit of a participant from the conference call.

In another embodiment, one or more electronic devices from the plurality of electronic devices, which are unable to support the enhanced conference call, can still be participants in an enhanced conference call. In such electronic devices, the conference call can be conducted in the conventional manner. In other words, in such electronic devices the various audio streams corresponding to various participants appear to come from a single audio source.

In an alternate embodiment of the invention, the present invention can be utilized to conduct a video conference call in a network. Video streams from each caller can be tiled on the display units of the electronic devices, and the audio streams can be positioned according the location of each participant on the display unit. In this embodiment, a CEO can use this invention to conduct a remote meeting with the board members of the company.

In another embodiment, in case of a broadband network, a wideband vocoder can be used for enhanced conference call experience. Examples of wide-band vocoder include, but are not limited to, an adaptive multi-rate wide-band (AMR-WB) vocoder, a variable-rate multimode wideband (VMR-WB) vocoder and so forth. A wideband vocoder provides enhanced voice quality as compared to a narrowband vocoder as it includes lower and upper frequency components of the speech signal, which are ignored by narrowband speech vocoders.

In the foregoing specification, the invention has been described with reference to specific exemplary embodiments; however, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

What is claimed is:

1. A method for performing a conference call in a network, the network including a plurality of electronics devices, the method comprising:
receiving audio streams from the plurality of electronic devices;
compiling the audio streams, wherein the audio streams received from different electronic devices are kept separate relative to each other;
transmitting the audio streams to the plurality of electronics devices; and
processing the audio streams in at least one electronic device, wherein the audio streams are audibly positioned in a virtual conference room associated with the at least one electronic device.

2. A method according to claim 1, wherein receiving the audio streams from the plurality of electronic devices further comprises:
decoding the audio streams; and
coding the audio streams with a coding algorithm to provide uniform audio quality to the plurality of electronic devices.

3. A method according to claim 1, wherein compiling the audio streams comprises tagging at least one audio stream with at least one tag, the at least one tag identifying the at least one audio stream.

4. A method according to claim 1, wherein processing the audio streams comprises:
splitting the audio streams into individual audio streams;
decoding the individual audio streams to generate one or more decoded audio streams; and
placing the one or more decoded audio streams in the virtual conference room according to a virtual conference room map displayed on the at least one electronic device.

5. A method according to claim 4, wherein the virtual conference room map can be modified by a user of the at least one electronic device to change arrangement of the one or more decoded audio streams.

6. A method according to claim 4, wherein a new participant entering the conference call gets automatically mapped in the virtual conference room map.

7. A system for performing a conference call in a network, the network including a plurality of electronics devices, the system comprising:
an aggregating unit located in at least one server for compiling audio streams, wherein the audio streams received from different electronic devices are kept separate relative to each other;
a transmitting unit operatively coupled to the aggregating unit for transmitting the audio streams to the plurality of electronics devices; and
a processing unit located in at least one electronic device, the processing unit capable of processing and positioning the audio streams in a virtual conference room associated with the at least one electronic device.

8. A system of claim 7, wherein the aggregating unit comprises:
a receiving unit for receiving the audio streams from the plurality of electronic devices.

9. A system of claim 8, wherein the receiving unit comprises:
at least one decoder for decoding the audio streams; and
at least one encoder operatively coupled to the at least one decoder for encoding each of the audio streams to provide uniform audio quality to the plurality of electronic devices.

10. A system of claim 7, wherein the aggregating unit comprises:
a tagging unit for tagging at least one audio stream with at least one tag, the at least one tag identifying the at least one audio stream.

11. A system of claim 7, wherein the processing unit comprises:
a splitting unit for splitting the audio streams into individual audio streams;
a decoding unit operatively coupled to the splitting unit for decoding the individual audio streams to generate one or more decoded audio streams; and
a positioning engine operatively coupled to the decoding unit for audibly placing the one or more decoded audio streams in the virtual conference room according to a virtual conference room map displayed on the at least one electronic device.

12. A system of claim 11, wherein the positioning engine further comprises:
a placing unit for altering arrangement of the one or more decoded audio streams on the virtual conference room map based on a user request; and
a position updating unit for passing co-ordinates of the one or more decoded audio streams to the positioning engine.

13. A system for performing conference call in a network, the network including a plurality of electronics devices, the system comprising:
at least one server for compiling audio streams received from the plurality of electronic devices, wherein the audio streams received from different electronic devices are kept separate relative to each other; and
at least one processing unit operatively coupled to the at least one server, the at least one processing unit being included in at least one electronic device from the plurality of electronic devices, wherein the at least one processing unit processes and positions the audio streams in a virtual conference room associated with the at least one electronic device.

14. A system of claim 13, wherein the at least one server comprises:
at least one decoder for decoding each of the audio streams from the plurality of electronic devices; and
at least one encoder operatively coupled to the at least one decoder for encoding each of the audio streams from the plurality of electronic devices to provide uniform audio quality to the plurality of electronic devices.

15. A system of claim 13, wherein the at least one server further comprises:
a receiving unit for receiving the audio streams from the plurality of electronic devices;
a tagging unit operatively coupled to the receiving unit for tagging at least one audio stream with at least one tag, the at least one tag identifying the at least one audio stream; and
a transmitting unit operatively coupled to the tagging unit for transmitting the audio streams to the plurality of electronics devices.

16. A system of claim 13, wherein the at least one processing unit comprises
a splitting unit for splitting the audio streams into individual audio streams;
at least one decoding unit operatively coupled to the splitting unit for decoding the individual audio streams to generate one or more decoded audio streams; and
a positioning engine operatively coupled to the at least one decoding unit for placing the one or more decoded audio streams in the virtual conference room according to a virtual conference room map displayed on the at least one electronic device.

17. A system of claim 16, wherein the positioning engine further comprises:
a placing unit for altering the arrangement of the one or more decoded audio streams on the virtual conference room map based on a user request; and
a position updating unit operatively coupled to the placing unit for passing co-ordinates of the one or more decoded audio streams to the positioning engine.

18. A conference call server capable of performing a conference call in a network, the network including a plurality of electronics devices, the conference call server comprising:
a receiver unit for receiving the audio streams from the plurality of electronic devices;
a processor unit operatively coupled to the receiver unit, wherein the processor unit compiles the audio streams such that the audio streams are kept separate from each other; and
a delivery unit operatively coupled to the processor unit, wherein the delivery unit delivers the audio streams to at least one electronic device.

19. A conference call server according to claim 18, wherein the receiver unit comprises:
at least one conference call decoder for decoding each of the audio streams from the plurality of electronic devices; and
at least one conference call encoder operatively coupled to the at least one conference call decoder for encoding each of the audio streams from the plurality of electronic devices to provide uniform audio quality to the plurality of electronic devices.

20. A conference call server according to claim 18, wherein the processor unit comprises:
a tagging unit, wherein the tagging unit tags at least one audio stream with at least one tag, the at least one tag identifying the at least one audio stream.

21. A communication device capable of performing a conference call in a network, the network including a plurality of communication devices, the communication device comprising:
a transceiver, wherein the transceiver transmits to the plurality of communication devices and the transceiver receives audio streams from the plurality of communication devices;
a audio processor, wherein the audio processor processes the audio streams received from the plurality of communication devices such that each of the audio streams are separate with respect to each other; and
a virtual conference room, wherein the virtual conference room provides a representation corresponding to each of the audio streams.

22. A communication device according to claim 21, wherein the audio processor comprises:
an audio splitter, wherein the audio splitter splits the audio streams received from the plurality of communication devices into individual audio streams;
a audio decoder, wherein the audio decoder is operatively coupled with the audio splitter for decoding the individual audio streams to generate one or more decoded audio streams; and
an audio positioning engine operatively coupled to the audio decoder for positioning the one or more decoded audio streams in the virtual conference room.

23. A communication device according to claim 22, wherein the audio positioning engine comprises:
an audio positioning unit for altering arrangement of the one or more decoded audio streams in the virtual conference room, wherein the altering of the arrangement is based co-ordinates of the one or more decoded audio streams.

24. A communication device according to claim 23, wherein the virtual conference room comprises:
a virtual conference room map, wherein the virtual conference room map displays each of the audio streams based on the audio positioning unit ; and
an audio unit, wherein the audio unit provides audio to a user based on the virtual conference room map.
